(19) United States
(12) Patent Application Publication
(10) Pub. No.: US 2021/0319541 A1
(43) Pub. Date: Oct. 14, 2021

(54) MODEL-FREE PHYSICS-BASED RECONSTRUCTION OF IMAGES ACQUIRED IN SCATTERING MEDIA

(71) Applicant: CARMEL HAIFA UNIVERSITY ECONOMIC CORPORATION LTD., Haifa (IL)

(72) Inventors: Tali TREIBITZ, Beer Ya'acov (IL); Deborah LEVY, Megadim (IL); Yuval GOLDFRACHT, Haifa (IL); Aviad AVNI, Moshav Dor (IL)

(21) Appl. No.: 17/273,731

(22) PCT Filed: Sep. 5, 2019
(86) PCT No.: PCT/IL2019/050995

§ 371 Date: Mar. 5, 2021

Related U.S. Application Data
(60) Provisional application No. 62/727,607, filed on Sep. 6, 2018.

(51) Int. Cl. G06T 5/00; G06N 3/08; G06K 9/62

(52) U.S. Cl. CPC G06T 5/008; G06N 3/08; G06K 9/6289; G06T 2207/20221; G06T 2207/20016; G06T 2207/20021; G06T 2207/10024

(57) ABSTRACT

A method comprising receiving a digital image acquired in a scattering medium, wherein the digital image comprises at least one color channel; for each of the at least one color channel: (a) calculating multiple sets of contrast stretch limits for the color channel, (b) calculating different contrast-stretched versions of the color channel, based on the multiple sets of stretch limits, (c) fusing the different contrast-stretched versions to produce an enhanced color channel; and reconstructing an enhanced digital image based on the at least one enhanced color channel.

### CROSS REFERENCE TO RELATED APPLICATIONS

This application claims the benefit of priority from U.S. Provisional Patent Application No. 62/727,607, filed on Sep. 6, 2018, entitled “ENHANCEMENT OF IMAGES ACQUIRED IN SCATTERING MEDIA BASED ON LOCAL CONTRAST FUSION,” the contents of which are incorporated by reference herein in their entirety.

### BACKGROUND

The invention relates to the field of automatic image correction.

Images acquired in scattering media (e.g., underwater, during sand or dust storm, in hazy weather) pose extreme challenges in detection and identification. This happens because of very low contrast caused by attenuation and scattering of the light by the medium.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in an embodiment, a method comprising receiving a digital image acquired in a scattering medium, wherein the digital image comprises at least one color channel; for each of the color channels: (i) calculating multiple sets of contrast stretch limits for the color channel, (ii) calculating different contrast-stretched versions of the color channel, based, at least in part, on the multiple sets of stretch limits, and (iii) fusing the different contrast-stretched versions to produce an enhanced color channel; and reconstructing an enhanced digital image based, at least in part, on the at least one enhanced color channel.

There is also provided, in an embodiment, a system comprising: at least one hardware processor; and a non-transitory computer-readable storage medium having stored thereon program code, the program code executable by the at least one hardware processor to: receive a digital image acquired in a scattering medium, wherein the digital image comprises at least one color channel; for each of the color channels: (i) calculate multiple sets of contrast stretch limits for the color channel, (ii) calculate different contrast-stretched versions of the color channel, based, at least in part, on the multiple sets of stretch limits, and (iii) fuse the different contrast-stretched versions to produce an enhanced color channel; and reconstruct an enhanced digital image based, at least in part, on the at least one enhanced color channel.

There is further provided, in an embodiment, a computer program product comprising a non-transitory computer-readable storage medium having program code embodied therewith, the program code executable by at least one hardware processor to: receive a digital image acquired in a scattering medium, wherein the digital image comprises at least one color channel; for each of the at least one color channel: (i) calculate multiple sets of contrast stretch limits for the color channel, (ii) calculate different contrast-stretched versions of the color channel, based, at least in part, on the multiple sets of stretch limits, and (iii) fuse the different contrast-stretched versions to produce an enhanced color channel; and reconstruct an enhanced digital image based, at least in part, on the at least one enhanced color channel.

In some embodiments, the calculating of the multiple sets of contrast stretch limits is based, at least in part, on: (i) dividing the color channel into multiple distinct blocks; and (ii) defining each of the multiple sets of contrast stretch limits based, at least in part, on pixel values of a different one of the multiple distinct blocks.

In some embodiments, said defining is based, at least in part, the number and magnitude of edges in each of the blocks.

In some embodiments, said fusing is based, at least in part, on a pixelwise fusion method.

in some embodiments, said pixelwise fusion method comprises generating, for each of the versions, a gradient pyramid, a Gaussian pyramid of color constancy criterion, and a Laplacian pyramid.

In some embodiments, said fusing comprises applying a neural network to said different contrast-stretched versions, wherein said neural network is trained based, at least in part, on optimizing a loss function based on image gradients, image color constancy, and a similarity metric with a desired image.

In some embodiments, the at least one color channel is three color channels: red, green, and blue.

In some embodiments, the number of the multiple distinct blocks is between 4 and 40.

In some embodiments, the method further comprises receiving, and the program instructions are further executable to receive, multiple ones of the digital image, as a digital video stream, to produce an enhanced digital video stream.

In some embodiments, the enhanced digital video stream is produced in real time.

In some embodiments, the method further comprises generating, and the program instructions are further executable to generate, based on the fusion of step (iii), a transmission map that encodes scene depth information for every pixel of the digital image.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 shows: on the left, a low-contrast underwater input image and three enlarged regions (A, B, C) of that image; on the right, an enhanced version of the image and the three enlarged regions (A′, B′, C′), in accordance with experimental results of the invention.

FIG. 2 shows: on the left, a low-contrast input image acquired during a sandstorm, and an enlarged region (A) of that image; on the right, an enhanced version of the image and the enlarged region (A′), in accordance with experimental results of the invention.

FIG. 3 shows: a flowchart of a method for enhancing an image, in accordance with some embodiments of the invention.

FIG. 4 shows: on the left, three low-contrast underwater input images; on the right, enhanced version of the three images, in accordance with experimental results of the invention.

### DETAILED DESCRIPTION

Disclosed herein is a technique for automated image enhancement, which may be particularly useful for images acquired in scattering media, such as underwater images, images captured in sandstorms, dust storms, haze, etc. The technique is embodied as a method, system, and computer program product.

Images acquired in scattering media pose extreme challenges in detection and identification of objects in the scene. This happens because of very low contrast caused by attenuation and scattering of the light by the medium. These images are difficult to correct, as the magnitude of the effect depends on the distance of the objects from the camera, which usually varies across the scene.

Therefore, present embodiments provide a local enhancement technique that varies with the distance of the objects from the camera. The basic image formation model in scattering media is that of Yoav Y. Schechner and Nir Karpel. Recovery of underwater visibility and structure by polarization analysis. IEEE J. Oceanic Engineering, 30(3):570-587, 2005: In each color channel c∈{R,G,B}, the image intensity at each pixel is composed of two components, attenuated signal and veiling-light:

I_{c}(x)=t_{c}(x)J_{c}(x)+(1−t_{c}(x))·A_{c}, (1)

where bold font denotes vectors, x is the pixel coordinate, I_{c} is the acquired image value in color channel c, t_{c} is the transmission of that color channel, and J_{c} is the object radiance that is to be restored. The global veiling-light component A_{c} is the scene value in areas with no objects (t_{c}=0, ∀c∈R, G, B). The transmission depends on object's distance z(x) and β_{c}, the water attenuation coefficient for each channel β_{c}:

t_{c}(x)=exp(β_{c}z(x)). (2)

Thus the recovery has the following form:

J_{c}(x)=[I_{c}(x)−(1−t_{c}(x))·A_{c}]/t_{c}(x), (3)

which basically performs a local contrast stretch on the image in the form of:

J_{c}(x)=[I_{c}(x)−U_{c}(x)]/V_{c}(x), (4)

where U is the DC factor and V is the scale that vary locally.

In some embodiments, the contrast stretch limits are defined by the number and magnitude of the edges in each of the blocks.

Some previous methods for enhancing images acquired in scattering media either divide the image to blocks and perform a local contrast stretch in each block separately, which leads to artifacts and visible boundaries, or try to evaluate the correct U, V values.

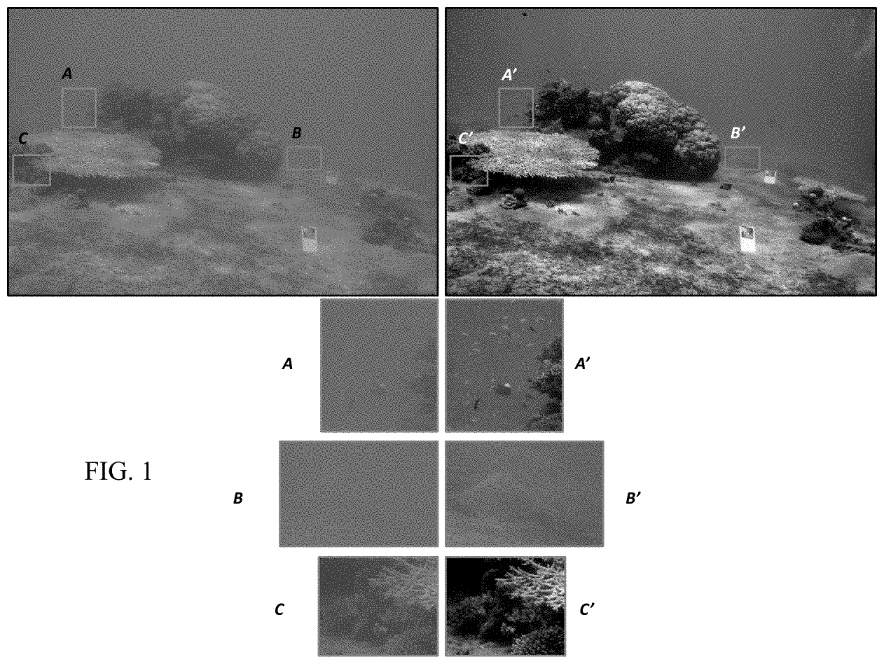

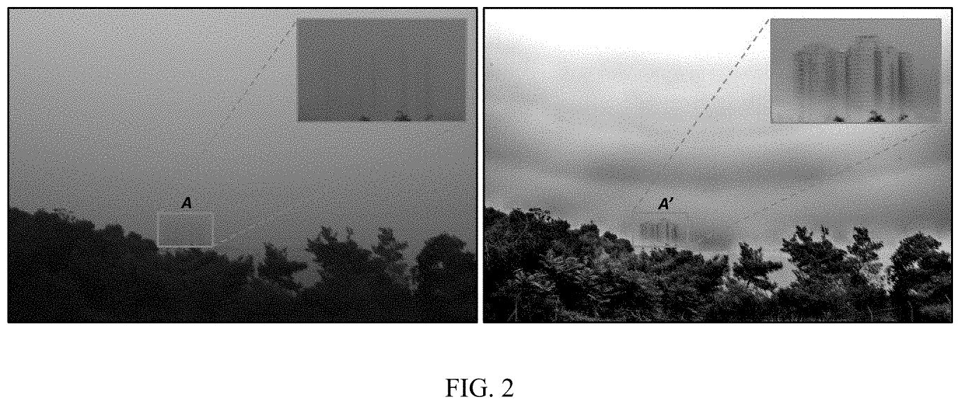

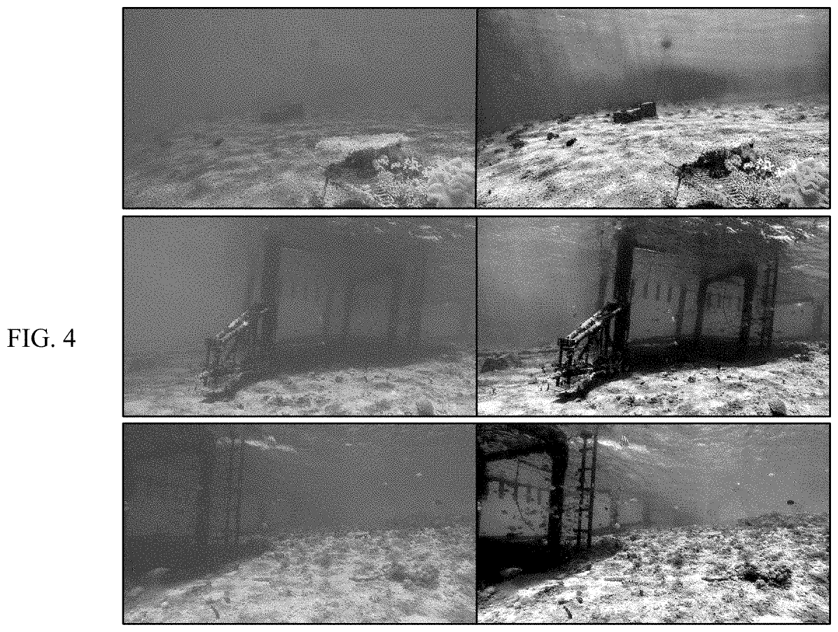

In present embodiments, instead of contrast-stretching separate blocks, the entire image is contrast-stretched several times with different values that are estimated from different areas in the image, or are provided not based on the image. For each of these values, the resulting contrast-stretched image has good contrast in the areas with distances that match the contrast stretch values. Objects at other distances will have less contrast or will be too dark. Then, to reconstruct the entire image, the contrast stretched image that looks the best is selected for each area, using multiscale image fusion. As this is conducted per pixel, artifacts associated with blocks are avoided, and the method results in the image with optimal contrast stretch at each area. As the present method concentrates on finding the optimal contrast stretch per area, even objects that are far away from the camera can be revealed (see FIGS. 1, 2, and 4).

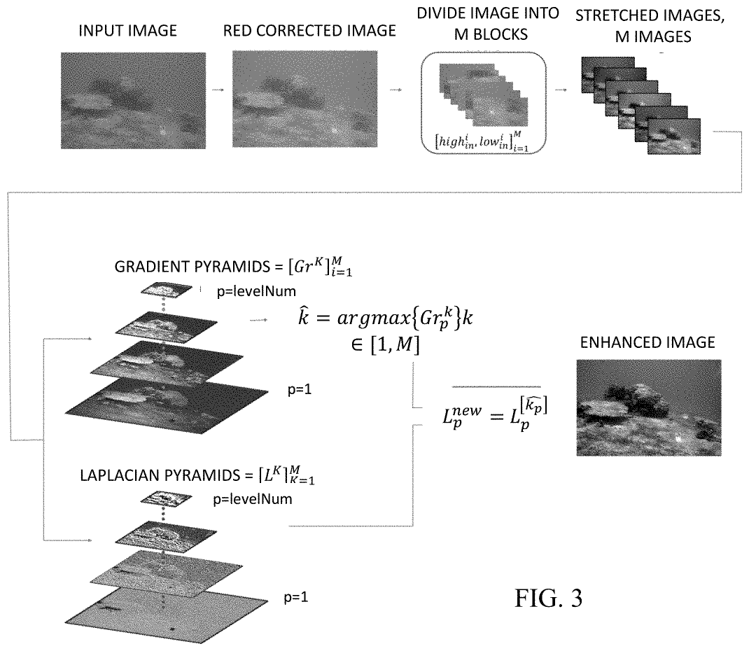

Following are the stages of the technique (also referred to as the “algorithm”), also illustrated in FIG. 3.

The first step is optional and is especially beneficial for underwater images (although it may be found useful for other types of images). Its purpose is to compensate for the red channel attenuation. If this stage is used, the red channel in the image is replaced with the corrected one in the rest of the algorithm. The rationale is to correct the red channel by the green channel which is relatively well-preserved underwater, especially in areas where the red signal is very low and mostly consists of noise. The correction is done by adding a fraction of the green channel to the red channel. In order to avoid saturation of the red channel during the enhancement stage the correction is proportional to the level of attenuation, i.e. if the value of the red channel before the correction is high, the fraction of green channel decreases. Moreover, in order to consent with the gray world assumption, the correction is also proportional to the difference between the mean values of red green and red channels. The red channel correction is conducted, in accordance with Codruta O Ancuti, Cosmin Ancuti, Christophe De Vleeschouwer, and Philippe Bekaert. Color balance and fusion for underwater image enhancement. IEEE Transactions on Image Processing, 27(1):379-393, 2018, as follows:

Iᵣ^{corrected}=Iᵣ+∝·(Ī_{g}+Īᵣ)·(1−Iᵣ)·I_{g}. (5)

Here, Iᵣ, I_{g} denote the red and green channels of the image, a is a constant which determines the amount of the correction, Īᵣ, Ī_{g} represent the mean value of Iᵣ, I_{g} and Iᵣ^{corrected} is the corrected red channel.

From now on, each step is conducted independently for each color channel.

A contrast stretch of an image is defined as:

$${I}_{streched} = ( {I}_{original} - {low}_{i n} ) ( \frac{{high}_{out} - {low}_{out}}{{high}_{in} - {low}_{in}} ) + {low}_{out} . \qquad ( 6 )$$

Here, lowᵢₙ,highᵢₙ are the lower and upper limits in the input image, and lowₒᵤₜ,highₒᵤₜ are the lower and upper values that define the dynamic range to stretch the image to. This means that the range [lowᵢₙ,highᵢₙ] in the input image is linearly mapped to the range [lowₒᵤₜ,highₒᵤₜ], where each value is a vector with RGB values. In the present case, lowₒᵤₜ=[0,0,0], highₒᵤₜ=[1,1,1] is used.

In the present method, stretching the image with various sets of limits are tried. The multiple sets of optional contrast stretch limits is found in the following second step: The image is divided into M blocks. Successfully experiments were conducted with M E [6,40], but other values are also possible. For each block, the stretch limits, {lowᵢₙ^{m}, highᵢₙ^{m}}_{m=1 . . . M}, are calculated independently. The stretch limits can be defined as the minimum and maximum pixels value in the block, or as the bottom d % and the top d % of all pixel values in the block, where d∈[0,1]. In some embodiments, the contrast stretch limits are sometimes defined by the number and magnitude of the edges in each of the blocks. The value of d % is optionally determined by the number of edges in each block. For blocks with a large number of edges, it may be inferred that there are enough features in the block, so d % will be low. For blocks with a small amount of edges, d % will be very high. In the present implementation, the edge map is generated by, e.g., a Canny edge detector algorithm (Canny, John. “A computational approach to edge detection.” Readings in computer vision. Morgan Kaufmann, 1987. 184-203.)

As an alternative to dividing the image into M blocks, the different sets of contrast stretch limits may be calculated, for example, based on a histogram of the entire image, or differently.

In the third step of the algorithm, for each of the m limits, M new images are generated by contrast stretching according to Eq. 6 using the different limits calculated in step two.

$${I}_{stretched}^{m} = ( {I}_{original} - {low}_{i n} ) \cdot ( \frac{{high}_{out} - {low}_{out}}{{high}_{in}^{m} - {low}_{in}^{m}} ) + {low}_{out} , \\ m = 1 … M \qquad ( 7 )$$

In the fourth step of the algorithm, the M images generated in the third step are fused using a multiscale decomposition with an appropriate criterion. In one case, three multi-scale decompositions are generated for each one of the M images. The first is a Laplacian decomposition (Peter J Burt and Edward H Adelson. The Laplacian pyramid as a compact image code. In Readings in Computer Vision, pages 671-679. Elsevier, 1987) Lₙ^{m}, m∈[1, M], n∈[1, N], where N is the number of levels in the pyramid. The second decomposition is a gradient pyramid, Dₙ^{m}, m∈[1, M], n∈[1, N]. The gradient pyramid is calculated as the magnitude of the gradient on a Gaussian pyramid in each level. The third decomposition is a Gaussian pyramid of a color constancy criterion. The color constancy criterion is calculated for each image by calculating the variance of the mean of each channel in different environments of the image. The environments are determined by the blocks that the image was divided to. The gradient and Gaussian pyramids are used as a pixelwise fusion criterion and/or method as follows:
a) The gradient's magnitudes are sorted for each pixel

K_n(x)={sort{Dₙ^{m}(x)},n=1 . . . N,m∈[1,M] (8)
b) From the top P number of images, the image with the lowest color constancy grade is selected for each pixel.

K_n(x)=argmin{{kₙ^{m}(x)},n=1 . . . N, (9)
c) Then, the Laplacian pyramid of the enhanced image is created:

Lₙ^{new}(x)=Lₙ^{[K}^{ₙ}^{(x)]}(x),n=1 . . . N. (10)

The enhanced image is reconstructed from its pyramid L^{new} by a standard Laplacian pyramid reconstruction and then combine the color channels to yield the final reconstructed image.

In some embodiments, the fusion step may be achieved by applying a deep network. In some embodiments, the inputs for the fusion neural network may be the multiple stretched images I_{stretched}^{m}, m∈[1, P]. The initial network layers are identical to all images (a Siamese network). The following layers are trained to fuse the images according to an appropriate loss function, such that the output is one enhanced image. The loss function can be based, for example, on minimizing gradients, color constancy, etc. Another option for the loss is to base it on a generative adversarial network (GAN), which looks for an output that is similar to an image taken above water.

The method was experimented with successfully on still images (see FIGS. 1, 2, and 4) as well as on underwater video streams, where the method was applied to frames of the video stream and an enhanced video was rendered.

Note that the method is also applicable, mutatis mutandis, to monochrome images and videos.

Using the above method, it is also possible to estimate the transmission tₓ(x) of each pixel of the image, resulting in a transmission map (also referred to as “depth map”) that encodes scene depth information for every pixel of the image.

When lowₒᵤₜ=[0,0,0], highₒᵤₜ=[1,1,1] is set, Eq. (6) becomes:

$${I}_{stretched} = ( \frac{{I}_{original} - {low}_{in}}{{high}_{in} - {low}_{in}} ) . \qquad ( 11 )$$

Comparing Eq. (10) to Eq. (4) implies that

t(x)=highᵢₙ(x)−low(x)ᵢₙ(x),(1−t_{c}(x))·A_{c}=lowᵢₙ(x). (12)

As Eq. (9) provides lowᵢₙ and highᵢₙ for each pixel as an output of the present algorithm, the transmission from one of the parts of Eq. (12) can be calculated using this output. This is similar in nature to the Dark Channel Prior of Kaiming He, Jian Sun, and Xiaoou Tang. Single image haze removal using dark channel prior. IEEE transactions on pattern analysis and machine intelligence, 33(12):2341-2353, 2011. However, the Dark Channel Prior works on patches and therefore is prone to artifacts while these values are calculated per pixel.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method comprising:
receiving a digital image acquired in a scattering medium, wherein the digital image comprises at least one color channel;
for each of the color channels:
(i) calculating multiple sets of contrast stretch limits for the color channel,
(ii) calculating different contrast-stretched versions of the color channel, based, at least in part, on the multiple sets of stretch limits, and
(iii) fusing the different contrast-stretched versions to produce an enhanced color channel; and
reconstructing an enhanced digital image based, at least in part, on the at least one enhanced color channel.

2. The method of claim 1, wherein the calculating of the multiple sets of contrast stretch limits is based, at least in part, on:
dividing the color channel into multiple distinct blocks; and
defining each of the multiple sets of contrast stretch limits based, at least in part, on pixel values of a different one of the multiple distinct blocks.

3. The method of claim 2, wherein said defining is based, at least in part, the number and magnitude of edges in each of the blocks.

4. The method of claim 1, wherein said fusing is based, at least in part, on a pixelwise fusion method.

5. The method of claim 4, wherein said pixelwise fusion method comprises generating, for each of the versions, a gradient pyramid, a Gaussian pyramid of color constancy criterion, and a Laplacian pyramid.

6. The method of claim 1, wherein said fusing comprises applying a neural network to said different contrast-stretched versions, wherein said neural network is trained based, at least in part, on optimizing a loss function based on at least one of: image gradients, image color constancy, and a similarity metric with a desired image.

7. The method of claim 1, wherein the at least one color channel is three color channels: red, green, and blue.

8. (canceled)

9. The method of claim 1, further comprising:
receiving multiple ones of the digital image, as a digital video stream; and
performing the method so as to produce an enhanced digital video stream.

10. (canceled)

11. The method of claim 1, further comprising:
based on the fusion of step (iii), generating a transmission map that encodes scene depth information for every pixel of the digital image.

12. A system comprising:
at least one hardware processor; and
a non-transitory computer-readable storage medium having stored thereon program code, the program code executable by the at least one hardware processor to:
receive a digital image acquired in a scattering medium, wherein the digital image comprises at least one color channel;
for each of the at least one color channel:
(i) calculate multiple sets of contrast stretch limits for the color channel,
(ii) calculate different contrast-stretched versions of the color channel, based, at least in part, on the multiple sets of stretch limits, and
(iii) fuse the different contrast-stretched versions to produce an enhanced color channel; and
reconstruct an enhanced digital image based, at least in part, on the at least one enhanced color channel.

13. The system of claim 12, wherein the calculating of the multiple sets of contrast stretch limits is based, at least in part, on:
dividing the color channel into multiple distinct blocks; and
defining each of the multiple sets of contrast stretch limits based, at least in part, on pixel values of a different one of the multiple distinct blocks.

14. The system of claim 13, wherein said defining is based, at least in part, the number and magnitude of edges in each of the blocks.

15. The system of claim 12, wherein said fusing is based, at least in part, on a pixelwise fusion method.

16. The system of claim 15, wherein said pixelwise fusion method comprises generating, for each of the versions, a gradient pyramid, a Gaussian pyramid of color constancy criterion, and a Laplacian pyramid.

17. The system of claim 12, wherein said fusing comprises applying a neural network to said different contrast-stretched versions, wherein said neural network is trained based, at least in part, on optimizing a loss function based on at least one of: image gradients, image color constancy, and a similarity metric with a desired image.

18. (canceled)

19. The system of claim 12, wherein the number of the multiple distinct blocks is between 4 and 40.

20. The system of claim 12, wherein said program instructions are further executable to:
receive multiple ones of the digital image, as a digital video stream; and
produce an enhanced digital video stream.

21. The system of claim 20, wherein the enhanced digital video stream is produced in real time.

22. The system of claim 12, wherein said program instructions are further executable to, based on the fusion of step (iii), generate a transmission map that encodes scene depth information for every pixel of the digital image.

23. A computer program product comprising a non-transitory computer-readable storage medium having program code embodied therewith, the program code executable by at least one hardware processor to:
receive a digital image acquired in a scattering medium, wherein the digital image comprises at least one color channel;
for each of the at least one color channel:
(i) calculate multiple sets of contrast stretch limits for the color channel,
(ii) calculate different contrast-stretched versions of the color channel, based, at least in part, on the multiple sets of stretch limits, and
(iii) fuse the different contrast-stretched versions to produce an enhanced color channel; and
reconstruct an enhanced digital image based, at least in part, on the at least one enhanced color channel.

24-33. (canceled)
